(19) United States
(12) Patent Application Publication
(10) Pub. No.: US 2026/0254403 A1
(43) Pub. Date: Aug. 27, 2026

(54) DOORS COMPRISING SOLAR PANEL AND METHOD OF MAKING THE SAME

(71) Applicant: PLASTPRO 2000, INC., Los Angeles, CA (US)

(72) Inventors: Shirley WANG, Los Angeles, CA (US); Pao Yu AN, Los Angeles, CA (US); Jian Cheng CHEN, Los Angeles, CA (US)

(73) Assignee: PLASTPRO 2000, INC., Los Angeles, CA (US)

(21) Appl. No.: 19/546,839

(22) Filed: Feb. 23, 2026

Related U.S. Application Data
(60) Provisional application No. 63/762,418, filed on Feb. 24, 2025.

(51) Int. Cl. H02S 20/30; E06B 7/28; E06B 9/24

(52) U.S. Cl. CPC H02S 20/30; E06B 7/28; E06B 9/24; E06B 2009/2476

(57) ABSTRACT

A door includes two skins and a glazing unit. Each skin has a skin body portion providing an outer door surface and defines an opening for the glazing unit. The glazing unit includes two glass panes with edge disposed between the skins. The glazing unit comprises a solar panel and a set of blinds or a switchable film. The set of blinds comprise a plurality of blades oriented in parallel. The door includes a rechargeable battery electrically connected with the solar panel and store electricity from the solar panel; and a motor mechanically connected with the set of the blinds or the switchable film and configured to direct the blinds or the switchable film by using power from the rechargeable battery. The door also includes a control on an exterior door surface, and can be also controlled via a remote control or through a mobile app on a smart phone.

### PRIORITY CLAIM AND CROSS-REFERENCE

This application claims the benefit of U.S. Provisional Application No. 63/762,418, filed Feb. 24, 2025, which application is expressly incorporated by reference herein in its entirety.

### FIELD

The disclosure relates to a door generally. More particularly, the disclosed subject matter relates to a door comprising a glazed unit having a solar panel, and the method of making the same.

### BACKGROUND

A glazed door is a door comprising one or more glass panes or panels. The glass panes in a glazed door may be translucent or transparent and provide desired decoration and optical clarity for the resulting door installed in residential and commercial buildings.

Fiberglass doors comprising synthetic polymers are used as substitutes for traditional wooden doors. Fiberglass doors include door skins (facings) secured to opposite sides of a rectangular door frame. A resulting cavity between the door skins and surrounded by the door frame optionally is filled with a core material. Doors so constructed can have wood graining printed, molded, or otherwise applied on the exterior surfaces of the door skins, and also raised paneling formed (e.g., molded) in the door skins. These features give the doors the appearance of natural wood fabricated products. Optionally, paint, stain, lacquer, and/or a protective layer may be applied to the exterior surface.

A solar panel is a device that converts sunlight into electricity by using photovoltaic (PV) cells. PV cells are made of materials that produce excited electrons when exposed to light. These electrons flow through a circuit and produce direct current (DC) electricity.

### SUMMARY

The present disclosure provides a door comprising a solar panel and a method of making the same. The present disclosure also provides a kit for making such a door. More particularly, the present disclosure provides a door comprising a glazing unit, which include a solar panel and a set of blinds (also called mini blinds) or a switchable film disposed inside the glazing unit. The set of blinds may be disposed between glass panes in the glazing unit in accordance with some embodiments. The switchable film may be disposed between glass panes or within one glass pane, or on one glass pane, in accordance with some embodiments. The solar panel is configured to generate enough power for daily operating the blinds or operating the switchable film. The switchable film comprises liquid crystals and is configured to change transparency upon application of electricity. The set of blinds or the switchable film may spread and cover the glass panels so as to block the sunlight or provide privacy to a resident inside a room.

In some embodiments, the door comprises a first skin, a second skin, and a glazing unit. The first skin includes a first skin body portion providing a first outer (e.g., interior) door surface. The second skin includes a second skin body portion providing a second outer (e.g., exterior) door surface. Each of the first skin and the second skin defines an opening for the glazing unit. Each of the skins defines an opening in its planar body portion for receiving the glazing unit. The openings may have a same size. The two skins combined also define an opening for the glazing unit. Each of the first skin and the second skin comprises a glass fiber filled polymer composite.

The glazing unit comprises one or more panes. In some embodiments, the glazing unit comprises two glass panes. The glazing unit has an edge disposed between the first skin and the second skin. The glazing unit is disposed within the opening.

In accordance with some embodiments, the glazing unit comprises a solar panel and a set of blinds disposed between the two glass panes. The set of blinds comprises a plurality of blades oriented in parallel or substantially parallel to each other, for example, in a horizontal direction. Each blade is made of a suitable material such as aluminum or aluminum alloy, other metals, or plastics, or any combination thereof. The plurality of blades are connected with strings.

The door further comprises a rechargeable battery. The rechargeable battery is electrically connected with the solar panel and stores electricity from the solar panel. A motor is mechanically connected with the set of the blinds and is configured to direct movement of the set of blinds by using power from the rechargeable battery.

The motor may be disposed between the two glass panes inside the glazing unit in some embodiments. In some embodiments, the motor may be disposed between the first and the second skins and outside the glazing unit. The rechargeable battery may be disposed inside or outside the glazing unit.

In some embodiments, the door further comprises a control (or controller) disposed on the first exterior surface defined by the first skin, and electrically connected with the rechargeable battery and the motor, respectively. The controller is configured to control, through the motor, rotation or other motion of each blade in the set of blinds and up-and-down motion of the set of blinds. In some embodiments, the rechargeable battery is disposed inside the controller.

In some embodiments, the door further comprises a switching circuit electrically connected with the solar panel and the rechargeable battery. The controller is configured to detect charging capacity of the rechargeable battery and turn on or off the switching circuit when the charging capacity is less than or reaches 100% so as to recharge or stop recharging of the rechargeable battery. If the battery is 100% charged, the solar panel does not need to generate additional electricity. The control may also include a charging port configured to charge the rechargeable battery if additional power is needed. The solar panel is configured to generate enough electricity for daily operation of the blinds. Only in special situation such as long-lasting rainy days, the system may need electricity from other sources.

In accordance with some embodiments, the glazing unit comprises a solar panel and a switchable film, which is disposed between the two glass panes or disposed within or on an interior surface of one glass pane. In some embodiments, the switchable film comprises a polymer film, which includes liquid crystals disposed thereon or sandwiched between two polymer films. Such a switchable film may be embedded into two glass sub-panes to provide one glass pane. The solar panel is configured to generate power for operating the switchable film. For example, when the power is off, the switchable film may be opaque or translucent. When the power is on, the switchable film becomes clear. The liquid crystals may be oriented in parallel with one another to provide the clarity.

In some embodiments, each door comprises a remote control, which is physically separate from the door, but wirelessly connected with the controller or the motor of the door. The remote control is configured to operate the miniblind or the switchable film.

The controller may be also configured to function via a mobile app in a smart device such as a smart phone, which is physically detached from the door.

The door may also comprise two stiles and two rails. The door may have a rectangular shape. The two stiles are aligned vertically along two vertical edges of the door, and the two rails are aligned horizontally along two horizontal edges of the door. The two skins may be bonded to the rails and stiles.

In some embodiments, the glazing unit comprises multiple panes comprising or made of inorganic or organic glass, or a combination thereof. For example, the glazing may comprise two panes, and a spacer between the two panes.

In some embodiments, the door further comprises a foamed material, for example, polyurethane (PU) foam, disposed between the first skin and the second skin. The foamed material and the edge of the glazing unit are disposed on two sides separated by the interlocking structure.

A kit for making a door as described herein also is disclosed. Such a kit comprises a first skin, a second skin, and a glazing unit. The glazing unit comprises the solar panel and the set of blinds or the switchable film as described herein. The first skin includes a first skin body portion providing a first outer door surface. The second skin includes a second skin body portion providing a second outer door surface. The glazing unit includes one or more panes, and has an edge shaped and sized to be disposed adjacent to and between the skins.

The kit may include the rechargeable battery and the motor as described herein. wherein each component is configured to be connected as described herein. For a door including the switchable film, no motor is needed.

The kit also includes the control and/or the switching circuit as described herein.

The kit may also comprise two stiles and two rails, or any other components for a door.

In another aspect, the present disclosure provides a method for making a door as described herein. The method comprises steps of providing a first skin and a second skin as described. The method further comprises a step of installing a glazing unit including one or more panes, and a solar panel and the blinds therein. The glazing unit has an edge disposed adjacent to and between tips of the two skins. The method further comprises connecting the two skins. The method also comprises providing or connecting a rechargeable battery and the motor and comprises installing a controller on an exterior door surface.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. Like reference numerals denote like features throughout specification and drawings.

The attached design drawings illustrate exemplary doors in accordance with some embodiments.

FIG. 1A is a plan view from a first side (e.g., interior side) illustrating an exemplary door in accordance with some embodiments.

FIG. 1B is a plan view from a second side (e.g., exterior side) illustrating the exemplary door of FIG. 1A.

FIGS. 1C-1D are sectional views illustrating the exemplary door in accordance with some embodiments. FIG. 1C shows a sectional view of the exemplary door and FIG. 1D shows a sectional view of the side of the exemplary door.

FIG. 2 is a plan and partial-open view illustrating a corner of the exemplary door having a battery and a motor for mini blinds in accordance with some embodiments.

FIG. 3 is a perspective view illustrating a portion of the exemplary door in accordance with some embodiments.

FIG. 4 is a perspective and sectional view illustrating a portion of the exemplary door in accordance with some embodiments.

FIG. 5 illustrates an exemplary scheme for connection of the components in the exemplary door in accordance with some embodiments.

FIG. 6 is a flow chart illustrating an exemplary method for making a door in accordance with some embodiments.

FIGS. 7A-7B are plan views from a first side (e.g., interior side) illustrating an exemplary door comprising a glazing unit, which includes a solar panel and a switchable film, in accordance with some embodiments. FIG. 7A illustrates that the glazing unit is opaque or translucent when the switchable film is powered on. FIG. 7B illustrates that the glazing unit is transparent (clear) when the switchable film is powered off.

FIG. 8 is a perspective view illustrating an exemplary door comprising a glazing unit, which includes a solar panel and a switchable film, in accordance with some embodiments.

FIG. 9A is a perspective view illustrating a top portion of an exemplary door of FIG. 8.

FIGS. 9B and 9C are plane view illustrating a remote control and a smart phone used to remotely control the exemplary door as described herein.

FIG. 10 is a plan view from a first side (e.g., interior side) illustrating an exemplary door comprising a glazing unit, which includes a solar panel and a switchable film, in accordance with some embodiments.

FIG. 11 is a sectional view illustrating a portion of the exemplary door of FIG. 10 showing the connection for the control in some embodiments.

FIG. 12 is a sectional view (in a vertical direction) illustrating the exemplary door of FIG. 10.

FIGS. 13A-13B are sectional views illustrating a top portion and a bottom portion of the exemplary door of FIG. 10.

FIG. 14 is a perspective and sectional view illustrating a portion of the exemplary door of FIG. 10 in accordance with some embodiments.

FIG. 15 is a sectional view (in a horizontal direction) illustrating the exemplary door of FIG. 10.

FIGS. 16A-16B are sectional views illustrating two corner portions of the exemplary door of FIG. 10.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure the singular forms “a,” “an,” and “the” include the plural reference, and reference to a particular numerical value includes at least that particular value, unless the context clearly indicates otherwise. Thus, for example, a reference to “an interlocking structure” is a reference to one or more of such structures and equivalents thereof known to those skilled in the art, and so forth. When values are expressed as approximations, by use of the antecedent “about,” it will be understood that the particular value forms another embodiment. As used herein, “about X” (where X is a numerical value) preferably refers to ±10 % of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless expressly indicated otherwise, references to “substantially normal (or perpendicular) to” used herein will be understood to encompass an intersection having an angle of about 90 degrees, for example, in the range of from 81 to 99 degrees.

Unless expressly indicated otherwise, references to “substantially parallel to” used herein will be understood to encompass an orientation of two lines or two planes being parallel or having an angle of less than 5 degrees, for example, less than 2 degrees or 1 degree.

References to “a glazing unit” made herein will be understood to encompass a unit comprising one or more panes or panels made of an inorganic glass, organic glass, or a combination thereof. A glazing unit is also known glazings, glass inserts, lights, or lites.

The terms “a glazing unit” and “an insulated glass unit (IGU)” used herein may be interchangeable.

The terms “solar panel” and “photovoltaic panel” used herein are interchangeable and refer to a photovoltaic (PV) device that converts light into electricity by using photovoltaic cells. PV cells are made of materials that produce excited electrons when exposed to light, which is not limited to sunlight only. The light may include moon light or light from any other source, and the light may include light of any suitable wavelength ranges, for example, visible light, infrared light, or ultraviolet light, or any combination thereof. These electrons generated from the PV cells can be collected to provide direct current (DC) electricity. The solar panel may be silicon such as polysilicon based.

The present disclosure provides a door comprising a solar panel and a method of making the same. The present disclosure also provides a kit for making such a door. More particularly, the present disclosure provides a door comprising a glazing unit, which include a solar panel and a set of blinds (also called mini blinds) or a switchable film disposed inside the glazing unit. The set of blinds may be disposed between glass panes in the glazing unit in accordance with some embodiments. The switchable film may be disposed between glass panes or within one glass pane, or on one glass pane, in accordance with some embodiments. The solar panel is configured to generate enough power for daily operating the blinds or operating the switchable film. The switchable film comprises liquid crystals and is configured to change transparency upon application of electricity. The set of blinds or the switchable film may spread and cover the glass panels so as to block the sunlight or provide privacy to a resident inside a room. The set of the blinds and the switchable film may be in two alternative embodiments, or co-exist in one embodiment.

The present disclosure provides a solar-powered mini-blind system or the switchable film integrated into fiberglass doors. In some embodiments, a solar panel is embedded within the insulated glass unit (IGU) of a door, enabling the blinds or the switchable film to be powered by solar energy. The system eliminates the need for external wiring or additional electrical units, offering a sleek, modern, and energy-efficient solution for door-installed blinds.

The solar-powered mini-blind (or switchable film) system for doors includes a solar panel integrated within the IGU of the door, eliminating the need for external units. The solar panel powers an embedded battery, which in turn powers a motorized mechanism for the operation of the mini-blinds. The system is designed to operate efficiently even under varying sunlight conditions and provides substantial energy savings by reducing the need for traditional electrical power sources.

The following descriptions are additional to the description in the Summary and the attached drawings. These do not exhaust the written descriptions based all the drawings. The exemplary embodiments are illustrated in the attached drawings.

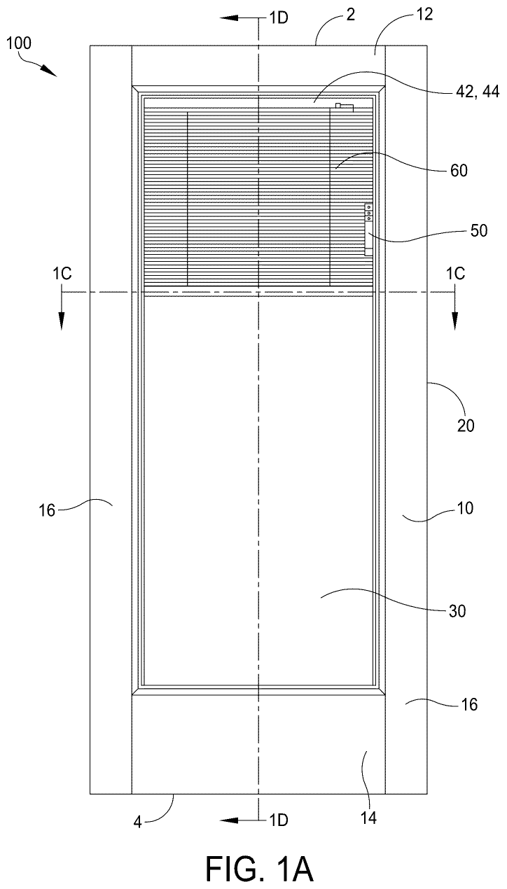

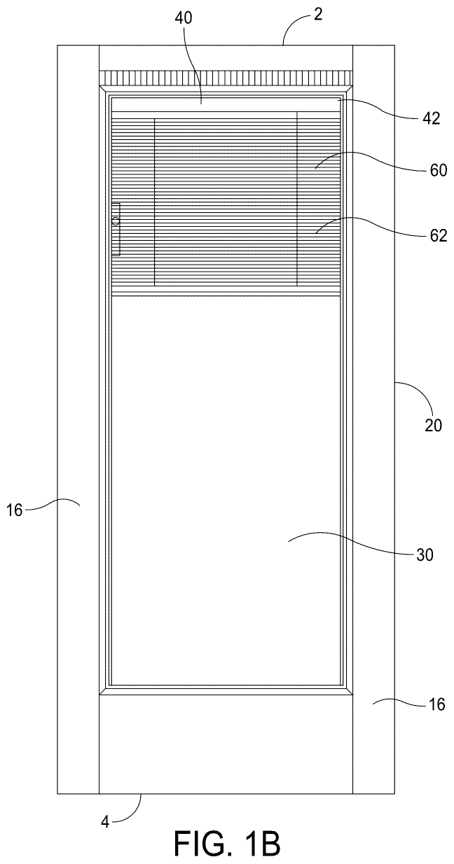

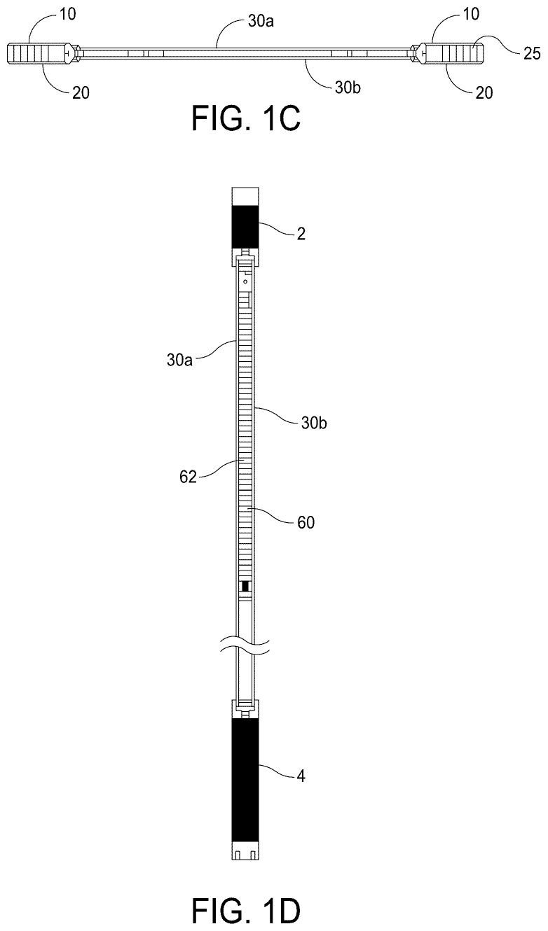

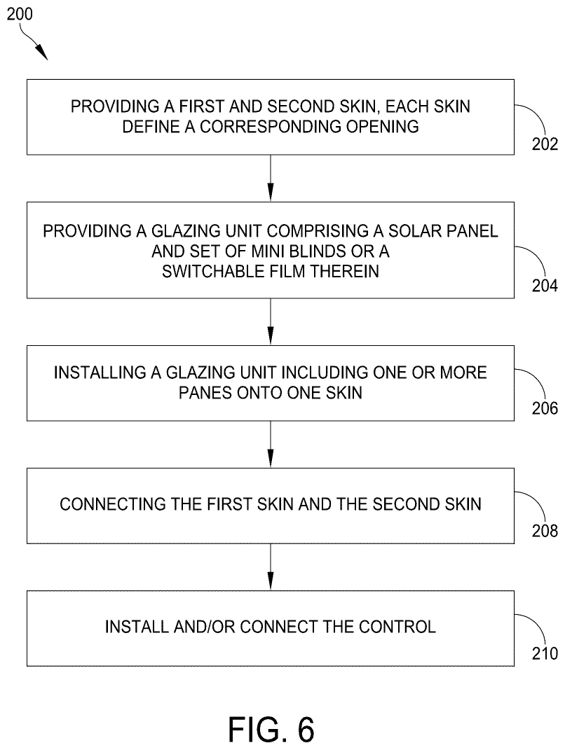

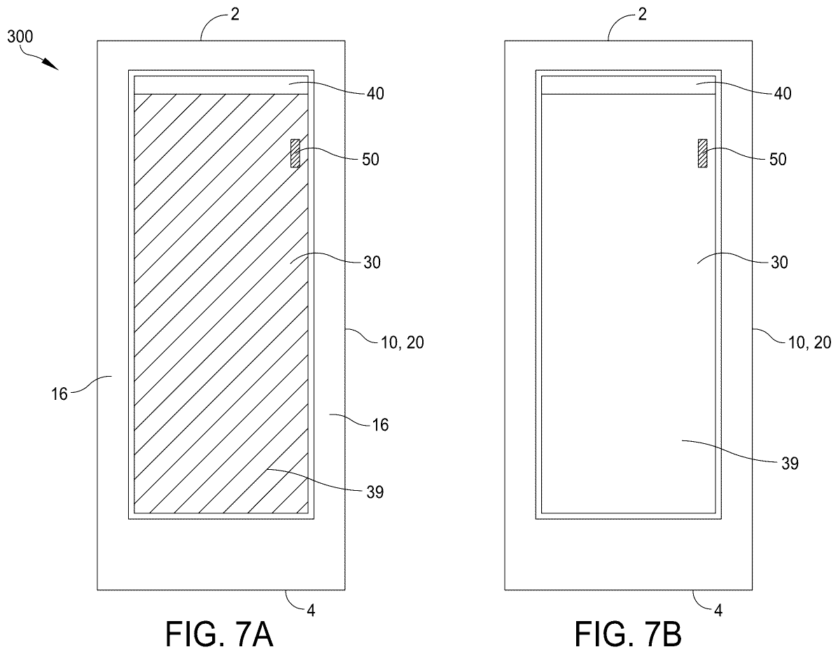

For example, FIGS. 1A-5 illustrate an exemplary door comprises a solar panel and a set of blinds in accordance with some embodiments. FIGS. 7A-16B illustrate an exemplary door comprises a solar panel and a switchable film in accordance with some embodiments. FIG. 6 illustrates a method for making an exemplary door comprising a solar panel and a set of blinds or a switchable film.

In FIGS. 1A-5 and 7A-16B, like items are indicated by like reference numerals, and for brevity, descriptions of the structure, provided above with reference to the preceding figures, are not repeated. The methods described in FIG. 6 are described with reference to the exemplary structures described in FIGS. 1A-5 and 7A-16B.

Referring to FIGS. 1A-1D, an exemplary door 100 in accordance with some embodiments is illustrated.

The door 100 comprises two skins including a first skin 10, a second skin 12, and a glazing unit 30. FIG. 1A is a plan view from a first side (e.g., interior side) illustrating an exemplary door 100 in accordance with some embodiments. FIG. 1B is a plan view from a second side (e.g., exterior side) of the exemplary door 100. FIGS. 1C-1D are sectional views illustrating the exemplary door. FIG. 1C shows a sectional view (C-C′) of the exemplary door and FIG. 1D shows a sectional view of the side (D-D′) of the exemplary door. FIG. 1C and FIG. 1D shows the horizontal and vertical sections, respectively. As illustrated in FIGS. 1A-1B, the door 100 may include a top portion 2 and a bottom portion 4, and the skins on the top, the bottom, and the sides are labelled as 12, 14, and 16, respectively.

The first skin 10 includes a first skin body portion providing a first outer (e.g., interior) door surface. The second skin 20 includes a second skin body portion providing a second outer (e.g., exterior) door surface. Each of the first skin 10 and the second skin 20 defines an opening for the glazing unit 30. Each of the skins defines an opening in its planar body portion for receiving the glazing unit. The openings may have a same size. The two skins combined also define an opening for the glazing unit 30. Each of the first skin 10 and the second skin 20 comprises a glass fiber filled polymer composite.

Each of the skins has a main body portion in the form of the front or back surface of the exemplary door and a flange portion connected with the main body portion (i.e. the surface portion). The first skin includes a first skin body portion providing a first outer (e.g., interior) door surface. The second skin includes a second skin body portion providing a second outer (e.g., exterior) door surface. Each skin may be a unitary molded structure. The skins may have flange portions, which have ends of complementary shapes and sizes and are interconnected to provide an interlocking structure such as a male-female interlocking structure. Each flange portion of each skin is substantially normal to the first skin body portion. The skins may have tips configured to hold and the glazing unit. The structure and the method of making a door having a glazed unit and an interlocking structure between the two skins are described in U.S. Pat. Nos. 10,968,683, and 11,473,364, which are incorporated herein by reference.

The glazing unit 30 comprises one or more panes (or panels), for example, 30a and 30b as illustrated in FIGS. 1C-1D, and has an edge disposed adjacent to and between the tips of the two skins. The glazing unit 30 is disposed within the opening.

The glazing unit 30 comprises a solar panel and a set of blinds 60 or a switchable film disposed inside the glazing unit 30. FIGS. 1A-5 illustrate an exemplary door comprises a solar panel and a set of blinds. The set of blinds 60 is disposed between the two glass panes, and is configured to rotate or move upward or downward. The set of blinds 60 comprises a plurality of blades 62 oriented in parallel or substantially parallel to each other. Each blade 62 is made of a suitable material such as aluminum or aluminum alloy, other metals, or plastics, or any combination thereof. The plurality of blades 62 are connected with strings.

The glazing unit 30 may include a spacer and a void between two adjacent glass panes. In some embodiments, the glazing unit 30 comprises multiple panes, which include or are made of inorganic or organic glass, or a combination thereof. For example, the glazing unit 30 may comprise two panes and a spacer between the two panes.

In some embodiments, the glazed unit 30 may include a plurality of panes, including first and second panes, which establish the opposite first and second sides of the glazed unit. The glazed unit 30 also may include a spacer disposed between the first and second panes. The spacer may extend adjacent each edge of the first and second panes. Each of the plurality of panes comprises inorganic glass, organic glass, or a combination thereof. In some embodiments, each pane comprises or is made of silica or silicate-based glass such as soda-lime glass. Unless expressly indicated otherwise, references to “organic glass” made herein will be understood to encompass unless any amorphous, solid, glasslike material made of transparent plastic, including but not limited to, polycarbonate, and polymethyl methacrylate (PMMA).

The door 100 may include a cavity, which is filled with a foamed material 25. In some embodiments, the foamed material is made of polyurethane (PU) foam, which is disposed between the first skin and the second skin.

Each of the skins defines at least one opening in its planar body portion for receiving and/or exposing the glazing unit. In some embodiments, the openings in the skins have a same size. The two skins combined also define an opening for one glazing unit. In some embodiments, the skins may be cut out to have two or three openings for multiple glazing unit. One of ordinary skill in the art will understand that the number of cutouts may vary. Each of the first skin and the second skin comprises or is made of a glass fiber filled polymer (e.g., polyester) composite in some embodiments.

The door 100 further comprises a rechargeable battery 42. The rechargeable battery 42 is electrically connected with the solar panel 40 and stores electricity from the solar panel 40. The rechargeable battery 42 is configured to provide power to direct movement of the set of blinds through a motor 44 mechanically connected with the set of the blinds, or change the transparency of the switchable film. The motor 44 may be mechanically connected with the set of the blinds 60 and is configured to direct movement of the set of blinds by using power from the rechargeable battery 42. In some embodiments, the battery 42 and the motor 44 may be covered by other components and may not be seen from outside of the door.

When the door includes a switchable film without the set of blinds, no motor is needed. The power can be provided from the rechargeable battery 42 to change the transparency of the switchable film. In some embodiments, the rechargeable battery 42 is disposed outside the glazing unit, and is disposed inside the controller.

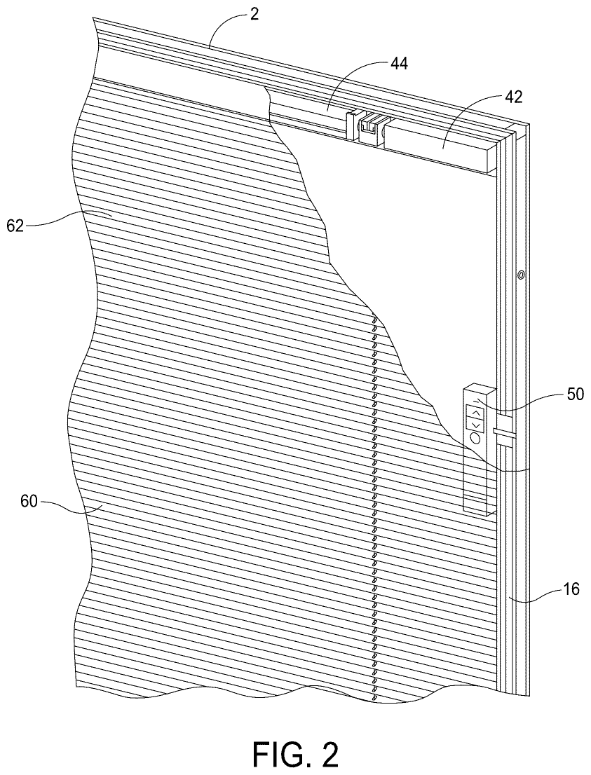

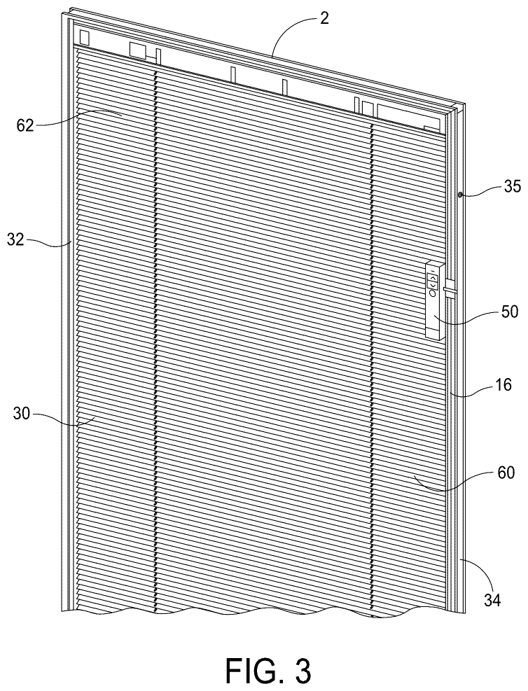

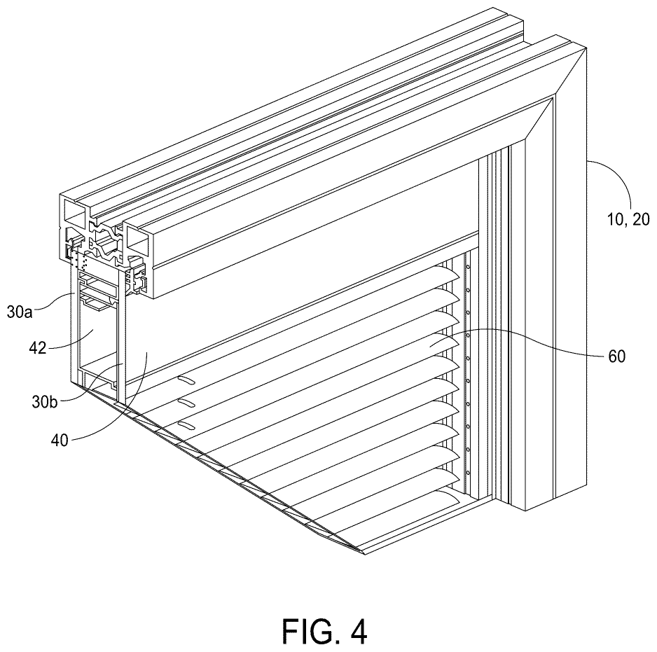

FIG. 2 is a plan and partial-open view illustrating a corner of the exemplary door 100 having a battery and a motor for mini blinds in accordance with some embodiments. FIG. 3 is a perspective view illustrating a portion of the exemplary door 100. FIG. 4 is a perspective and sectional view illustrating a portion of the exemplary door 100.

Referring to FIG. 2, the rechargeable battery 42 and the motor 44 are disposed between the two glass panes 30a, 30b inside the glazing unit 30 in some embodiments. In some embodiments, they can be disposed between the first skin 10 and the second skin 20 and outside the glazing unit 30.

In some embodiments, the door further comprises a control (or controller) 50.

The location of the battery 42 in FIG. 2 is for illustration only. In some embodiments, the rechargeable battery 42 may be preferably disposed outside the glazing unit, and is disposed inside the controller 50.

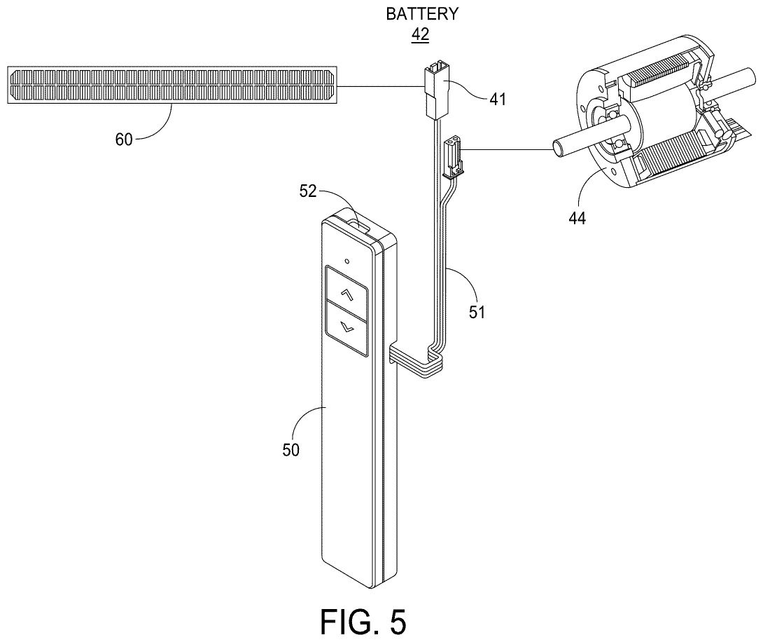

Referring to FIGS. 1A, 2 and 3, the control (or controller) 50 is disposed on the first exterior surface defined by the first skin 10, and electrically connected with the rechargeable battery 42, which is connected with the motor 44. The first exterior surface is a surface facing the interior of a room. The controller 50 may include “up” and “down” buttons. The controller 50 is configured to control, through the motor, rotation or other motion of each blade 62 in the set of blinds and up-and-down motion of the set of blinds 60. When the door include a switchable film the controller 50 may be used to control the transparency of the switchable film. The controller 50 may include a charging port 52 (as illustrated in FIG. 5), for example, a Type C charging port, for connecting with a charging cable for external charging if needed.

As illustrated in FIG. 3, the door may include a hole 35 (or called gas valve) on the side. The gas valve is used to vent hot air inside the door, for example, between glass panes, so that a suitable air pressure is maintained. The blades 62 for the blinds are made of aluminum alloy, which is light-weighted and also opaque to exterior block light. The blades 62 for the blinds are made of aluminum alloy, ensuring durability and efficiency in integration with the glass panels. The spacer between glass panes is made of aluminum. The door 100 may also include other sealants 32, 34, for example, silicone, polyurethane, butyl rubber, inside and outside the door. The sealants 32, 34 may be disposed around the glazing unit 30. The glass panes are made of a glass, which is tempered and has high transparency. The glass may be “low-iron glass” having low impurity content.

Referring to FIG. 4, in the exemplary door 100, the skins 10, 20, the set of blinds 60, the solar panel 40, and the glass panes 30a, 30b are shown. The solar panel 40 has its photovoltaic layer facing outside a room to accept light. Behind the solar panel 40 and also between the two glass panes, there are void(s), where the motor 44 can be placed. The spacer for adjusting the space between glass panes is also disposed inside the void. Or in another word, the void may be provided by the glass panes with the spacer in between. The void is also referred as a “channel.”

The solar panel 40 is seamlessly integrated into the channel at the top of the door, within the IGU. This design allows the solar panel to charge during the day, storing energy in a high-capacity battery embedded in the system. The system uses advanced Maximum Power Point Tracking (MPPT) technology to ensure efficient energy conversion even in low light or vertical installations.

A Maximum Power Point Tracking (MPPT) charge controller optimizes solar power systems by electronically tracking the highest power output of panels. The technology of “Maximum Power Point Tracking” is used in solar electric charge controllers. A maximum power point tracker is an electronic DC to DC converter that optimizes the match between the solar array (PV panels) and the battery. It converts a higher voltage DC output from solar panels down to the lower voltage needed to charge batteries. A MPPT charge controllers increase solar system efficiency by electronically tracking and adjusting the electrical operating point of solar panel(s) to ensure they operate at their maximum power output. These devices convert higher voltage, lower current power from panels into lower voltage, higher current power to optimize battery charging.

In some embodiments, the door 100 may have two pieces of solar panel 40, one of which faces outside of the door or house (or other building), and one of which faces interior of a house and is configured to absorb light from interior.

FIG. 5 illustrates an exemplary scheme for connection of the components in the exemplary door in accordance with some embodiments. The controller 50 is electrically connected with the rechargeable battery 42 (and also the solar panel 40) and the motor 44, respectively. Connectors 41 and wires 51 may be used for connections. The controller 50 is configured to control, through the motor, rotation or other motion of each blade in the set of blinds and up-and-down motion of the set of blinds. The controller 50 may have a surface panel with control buttons such as an upward arrow and a downward arrow. When each arrow or button is pressed, related function will be operated. The upward arrow is for lifting the blinds to consolidate them together to the top. The downward arrow is for releasing the blinds downward. The control may also have one button for rotating each blade so that all the blades are oriented horizontally or vertically or at an angle for adjust light coming into a house. When the door 100 comprises a switchable film, without the blinds, the upward arrow may be for powering up so that the switchable film is clear, and the downward button is for powering off so that the switchable film is opaque or translucent.

The controller 50 may also be configured to control the solar panel 40 and the battery 42. For example, in some embodiments, the door further comprises a switching circuit (not shown) electrically connected with the solar panel 40 and the rechargeable battery 42. The controller 50 is configured to detect charging capacity of the rechargeable battery 42 and turn on or off the switching circuit when the charging capacity is less than or reaches 100% so as to recharge or stop recharging of the rechargeable battery 42. If the battery is 100% charged, the solar panel does not need to generate additional electricity.

The electricity generated by the PV cells are collected in the rechargeable battery 42 and is used to power the motorized functions of the blinds, including up/down movement and tilt adjustment, thus eliminating the need for an external power source.

The controller 50 may also include a charging port 52, for example, Type-C charging port, which is configured to charge the rechargeable battery if additional power is needed. The controller 50 may be also wirelessly charged. The solar panel 40 is configured to generate enough electricity for daily operation of the blinds. Only in special situation such as long-lasting rainy days, the system may need electricity from other sources.

The controller 50 may also have an indication light to indicate whether the power is on or off. When the power is on, the indicator light is on. In some other embodiments, for example, a green light indicates that the battery is charged and a red light shows that the battery is not sufficiently charged. A blinking light may indicate the battery is being charged, for example, by the electricity from the solar panel.

The controller 50 may also include a display screen showing the charging capacity by percentage of the battery. For example, “50%” means 50% charged, and “100%” or “full” means 100% charged.

In some embodiments, the wires 51 for connecting with the control pass through a small slot created at the edge of the glass panel, preserving the structural integrity of the door. The wires connect seamlessly with the control while maintaining the visual appeal of the set-up.

In some embodiments, the electricity generated by the PV cells is collected in a built-in battery via the controller 50. The built-in battery is the rechargeable battery and may be disposed inside or outside the control.

In some embodiments, the control system includes a remote control, which is wirelessly connected with the controller 50 and configured to direct the control to function as described herein. The remote control is physically detached from the controller and configured to wirelessly coupled with the controller to direct the movement of the set of blinds or change the transparency of the switchable film. In some embodiments, the controller 50 is configured to function via a mobile app in a smart device such as a smart phone, which is physically detached from the door 100.

The system may have a suitable combination of battery and energy storage. In some embodiments, the system utilizes a battery of a suitable capacity such as a 2000 mAh battery, capable of powering the motorized blinds for approximately 80 cycles on a full charge. The system can operate without direct sunlight for several days, depending on usage. It also includes a backup option for charging, such as charging or USB-C, to ensure continuous operation when sunlight is limited. The charging can be wire charging or wireless charging.

The energy stored in the battery powers an ultra-quiet motor, enabling automated operation of the blinds, including opening, closing, and tilting. The system may integrate with home automation devices, such as Google Home and Alexa, for voice or app-based control. The system has features of smart integration. The system offers compatibility with smart home devices for added convenience.

The door 100 may also comprise two stiles and two rails. The door may have a rectangular shape. The two stiles are aligned vertically along two vertical edges of the door, and the two rails are aligned horizontally along two horizontal edges of the door. The two skins may be bonded to the rails and stiles.

In some embodiments, the glazing unit 30 comprises multiple panes comprising or made of inorganic or organic glass, or a combination thereof. For example, the glazing may comprise two panes, and a spacer between the two panes.

In some embodiments, the door 100 further comprises a foamed material, for example, polyurethane (PU) foam, disposed between the first skin and the second skin. The foamed material and the edge of the glazing unit are disposed on two sides separated by the interlocking structure.

In another aspect, the present disclosure provides the system as described herein. The system comprises the door as described herein. It also has the features of smart integration and is compatible with smart home devices.

The system also has high durability and weather resistance. For example, in some embodiments, in the door as described herein, the solar panel system is rated IP65 for weather resistance, making it suitable for both interior and exterior fiberglass doors. The blinds are designed to withstand various weather conditions, including rain, snow, and extreme temperatures ranging from 32° F. to 158° F. (0° C. to 70° C.).

In another aspect, a kit for making a door as described herein also is disclosed. Such a kit comprises a first skin, a second skin, and a glazing unit. The glazing unit comprises the solar panel and the set of blinds. The first skin includes a first skin body portion providing a first outer door surface. The second skin includes a second skin body portion providing a second outer door surface. The glazing unit includes one or more panes, and has an edge shaped and sized to be disposed adjacent to and between the skins.

The kit may include the rechargeable battery and the motor as described herein. wherein each component is configured to be connected as described herein.

The kit also includes the control and/or the switching circuit as described herein.

The kit may also comprise two stiles and two rails, or any other components for a door.

In another aspect, the present disclosure provides a method for making a door as described herein. The method comprises steps of providing a first skin and a second skin as described. The method further comprises a step of installing a glazing unit including one or more panes, and a solar panel and the blinds therein. The glazing unit has an edge disposed adjacent to and between tips of the two skins. The method further comprises connecting the two skins. The method also comprises providing or connecting a rechargeable battery and the motor and comprises installing a control on an exterior door surface.

FIG. 6 is a flow chart illustrating an exemplary method 200 for making a door in accordance with some embodiments.

At step 202, a first skin 10 and a second skin 20 are provided. Each skin may be molded as a unitary structure. The skins may be cut out to provide an opening for the glazing unit. The skins may have complementary shapes and sizes for an interlocking structure.

In some embodiments, each of the first skin 10 and the second skin 20 is molded in a molded prototype comprising an extra piece, which can be removed after molded. For example, each skin body of the respective skin includes a molded middle portion that is later cut out to define an opening for accepting the glazing unit.

In some embodiments, the door skins are opaque. Opaque door skins may be used for making other door products.

At step 204, a glazing unit 30 including one or more panes such as two panes is provided. The glazing unit 30 comprises a solar panel 40 and a set of mini blinds 60 (or a switchable film) as described herein. The solar panel 40 and the set of mini blinds 60 are disposed inside the glazing unit, for example, between two glass panes. The solar panel may be disposed at one end of the glazing unit. The solar panel comprises photovoltaic active layer or layers facing the exterior surface and is configured to accept lights such as sun or moon lights. The set of mini blinds is disposed in the middle of the glazing unit. The mini blinds comprise a plurality of blades 62 connected with each other and oriented to be parallel or substantially parallel to each other. The blades 62 are configured to be rotatable (or called tiltable) for adjust lighting when the blades are in an expanded state. The set of blades are configured to be retracted to one end, with the blades layered among another in a compact mode. The blade is made of a metal such as aluminum or aluminum alloy and connected with strings.

In some embodiments, the solar panel further comprises a rechargeable battery and a rotor for controlling the motion including rotation (or called tilt adjustment) of the mini blinds. The rechargeable battery is electrically connected with the solar panel and is configured to accept and store the electricity generated by the solar panel. The battery is configured to provide enough electricity for the blind operation. When the battery is in full capacity, it will stop accepting the electricity. The motor is mechanically connected with the mini blinds.

In some embodiments, the rechargeable battery and the rotor may also be disposed outside the glazed unit.

At step 206, the glazing unit is installed to be connected with one skin such as the first skin. A glazing unit is coupled to the first skin. Adhesive or sealant may be optionally applied. A glazing unit including one or more panes such as two panes is installed.

At step 208, the second skin is applied and assembled with the first skin and the glazing unit. The glazing unit may be disposed inside the opening of the skins. The first skin and the second skin are connected to provide the interlocking structure, through the structures such as protrusion and recess. The first skin and the second skin are assembled together, for example, connected to provide the interlocking structure.

At step 210, a control is installed and connected. The connections and the functions of the control are described as herein.

The exemplary door provided in the present disclosure may have a rectangular shape with stiles (not shown) aligned vertically along two vertical edges of the door and rails (not shown) aligned horizontally along two horizontal edges of the door. A quadrilateral frame may be used in some embodiments. Such a door frame may be formed of a top rail, a bottom rail, a right stile and a left stile joined together to form said frame. In some embodiments, the door comprises a top rail, a bottom rail, a right stile and a left stile joined together to form a frame quadrilateral door frame. The skins are joined together through the interlocking structure. The two skins may be bonded to the rails and stiles. The method may also comprise steps of assembling stiles and rails, and bonded skins to the stiles and rails.

Each component may be made of any suitable material. For example, the skins comprise a material of a glass fiber or mineral reinforced polymer composite. The stiles and the rails may comprise laminated veneer lumber (LVL), a composite comprising wood and polyvinyl chloride, or any other suitable materials. In some embodiments, fiberglass door skins are formed of sheet molding compound (or SMC) sheets containing resinous sheets reinforced with fiberglass, often chopped fiberglass or fiberglass mats.

The built-In battery has high capacity, and the standby time after a full charge can be up to 42 weeks. The USB-C charging time may be less than three hours to fully charge an empty battery. The solar charging time is relatively short. For example, it may take one or several days to fully charge an empty battery, when exposed to 10,000 lux light. The system also includes a low-voltage alert, for example, that the red light flashes quickly three times.

The door and the system also have good operation capacity. For example, at full charge, the system can support approximately 1.5 hours of continuous (non-stop) operation of a blind set having an area of 1.34 square meter.

For a door having a switchable film, in the power-on mode, the glazing unit has a high switching speed, for example, reaching full clarity under 10 milliseconds. In the frosted mode (i.e., power off mode), the glass returns to maximum frosting within tens of milliseconds.

In some embodiments, the system may be operated at direct current with several volts. The operating temperature may be in a broad range of temperature from low to temperatures, for example, from −10° C. to 55° C. or in a range of from 0° C. to 55° C.

FIGS. 7A-16B illustrate an exemplary door 300 comprises a solar panel and a switchable film in accordance with some embodiments. The descriptions with respect to the exemplary door 100 in FIGS. 1A-5 except the set of blinds are also applicable to the exemplary door 300, and are not repeated. The labels and the descriptions for the exemplary doors 100 and 300 can be exchangeable.

FIGS. 7A-7B are plan views from a first side (e.g., interior side) illustrating an exemplary door comprising a glazing unit, which includes a solar panel and a switchable film, in accordance with some embodiments. FIG. 7A illustrates that the glazing unit is opaque or translucent when the switchable film is powered on. FIG. 7B illustrates that the glazing unit is transparent (clear) when the switchable film is powered off.

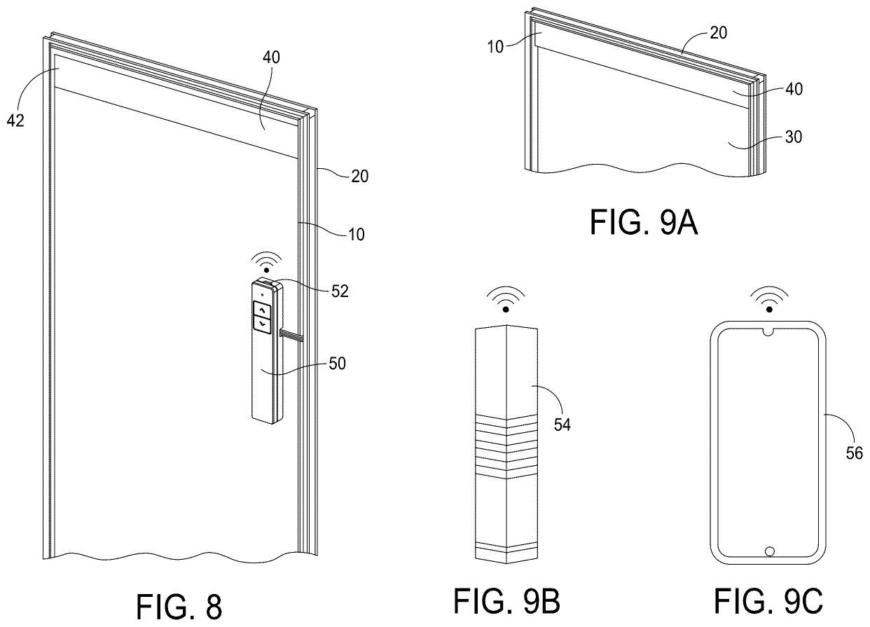

FIG. 8 illustrates an exemplary door 300 comprising a glazing unit 30, which includes a solar panel 40 and a switchable film 39, in accordance with some embodiments. FIG. 9A illustrates a top portion of the exemplary door of FIG. 8. FIGS. 9B and 9C illustrate a remote control 54 and a smart device 56 such as a smart phone used to remotely control the exemplary door 300 (or 100) as described herein.

Such a door 300 comprises a first skin 10 including a first skin body portion providing a first outer door surface, and a second skin 20 including a second skin body portion providing a second outer door surface. Each of the first skin and the second skin defines an opening. A glazing unit 30 comprises two glass panes 30a, 30b. The glazing unit 30 has an edge disposed between the first skin 10 and the second skin 20. The glazing unit 30 is disposed within the opening.

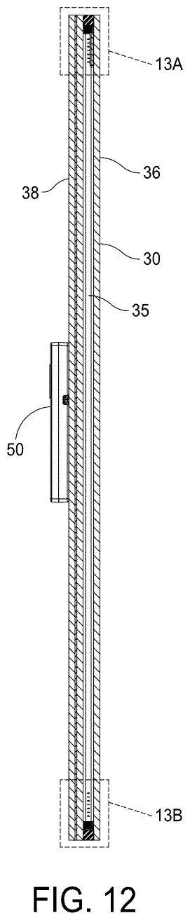

The glazing unit 30 comprises a solar panel 40 and a switchable film 39 (shown in FIGS. 12, 13A-16B) disposed inside the glazing unit 30. The switchable film 39 comprises liquid crystals and is configured to change transparency upon application of electricity. The exemplary door 300 also includes a rechargeable battery 42 electrically connected with the solar panel 40 and store electricity from the solar panel 40. The rechargeable battery 42 may be covered by the solar panel 40 or a decorative panel, so it may not be seen from the exterior of the door. The rechargeable battery 42 is configured to provide power for changing the transparency of the switchable film 39. The switchable film is disposed inside or on the surface of one of the two glass panes 30a, 30b in some embodiments. The location of the rechargeable battery 42 in FIG. 8 is for illustration only. In some embodiments, the rechargeable battery 42 disposed outside the glazing unit, for example, disposed inside the controller 50.

For the door 300, a system may further comprise a remote control 54. The remote control 54 may be wirelessly connected with the controller 50 and is configured to direct the control to function as described herein. The remote control 54 is physically detached from the controller 50 and configured to wirelessly coupled with the controller to change the transparency of the switchable film 39. In some embodiments, the controller 50 is configured to function via a mobile app in a smart device 56 such as a smart phone, which is physically detached from the door 100.

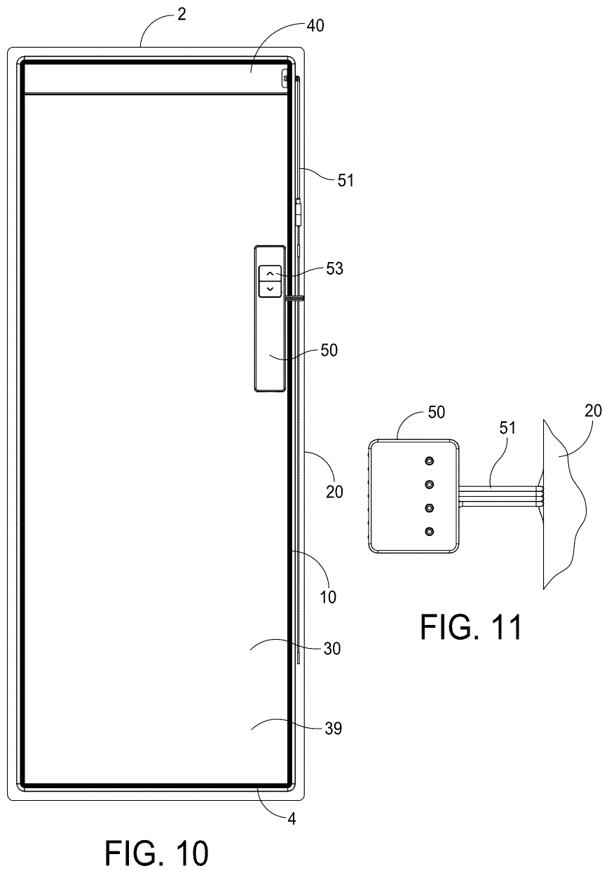

FIG. 10 is a plan view from a first side (e.g., interior side) illustrating an exemplary door 300 comprising a glazing unit, which includes a solar panel 40 and a switchable film 39, in accordance with some embodiments. FIG. 11 is a sectional view illustrating a portion of the exemplary door of FIG. 10 showing the connection for the control in some embodiments.

Referring to FIG. 10, the solar panel 40 may be placed toward to the top portion 2 of the exemplary door. The glazing unit 30 includes the switchable film 39 therein, which may be disposed parallel to glass panes and spreads vertically across the area of the glazing unit from the top portion 2 to the bottom portion 4. The controller 50 is disposed on an exterior surface (interior side) facing inside of a room. The controller 50 may be connected with the solar panel 40 and/or a rechargeable battery 42 via wires 51 and may include buttons 53 such as upward and downward buttons as described herein. In some embodiments, the battery 42 is disposed outside the glazing unit and may be disposed inside the controller 50. Referring to FIG. 11, multiple wires 51 may be connected with multiple ports of the controller 50 and the wires 51 may be disposed along an edge of the door or the glazing unit and then connected with the solar panel 40.

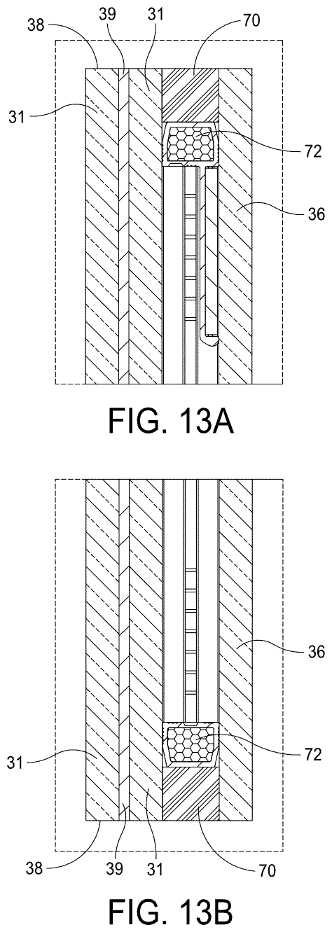

FIG. 12 is a sectional view (in a vertical direction) illustrating the exemplary door of FIG. 10. FIGS. 13A-13B are sectional views illustrating a top portion and a bottom portion of the exemplary door of FIG. 10.

Referring to FIGS. 12 and 13A-13B, the glazing unit 30 includes two glass panes 36 and 38, which are the examples of the glass panes 30a, 30b as described. There might be a gap between these two glass panes. Glass pane 36 is one layer of glass. Glass pane 38 has a sandwich structure comprising two glass layers 31 and a switchable film 39 disposed between the two layers 31 of glass. In some embodiments, the switchable film may be disposed on a surface of a glass pane 36 or 38, or may be disposed between two glass panes 36, 38.

In some embodiments, the glass pane 36, which may be on the exterior side and is configured to face outside a room, maybe a low-E glass. The controller 50 is disposed on the surface of the glass pane 36.

The switchable film 39 include liquid crystals such as polymer dispersed crystals. The switchable film 39 is configured to orient the liquid crystals under electrical field and become transparent when it is powered on, and become opaque or translucent when it is powered off. The switchable film 39 may be disposed inside or on the surface of one of the two glass panes, and the switchable film is configured to orient the liquid crystals and become transparent when it is powered on. The liquid crystals are in random orientations, and the switchable film become opaque (or called frosted or hazy) or translucent when it is powered off.

The switchable film 39 may include at least one polymer layer, which is made of a polymer such as ethylene vinyl acetate (EVA) polymer film. Such a polymer film may be transparent. The switchable film 39 may include two EVA films and a PDLC (polymer dispersed liquid crystal) layer sandwiched between the two EVA films. In some embodiments, the switchable film 39 may include an EVA film and a PDLC layer disposed on the EVA film, and together with a layer 31 of glass, a sandwich layer including the EVA film, the PDLC layer, and the glass layer 31 may be formed.

In some embodiments, the door 300 may also include a structural adhesive 70 disposed between the two glass panes 36 and 38, and a drying portion 72 comprising molecular sieve or other drying agents disposed between the two glass panes 36 and 38 and close to the gap between the two glass panes 36 and 38.

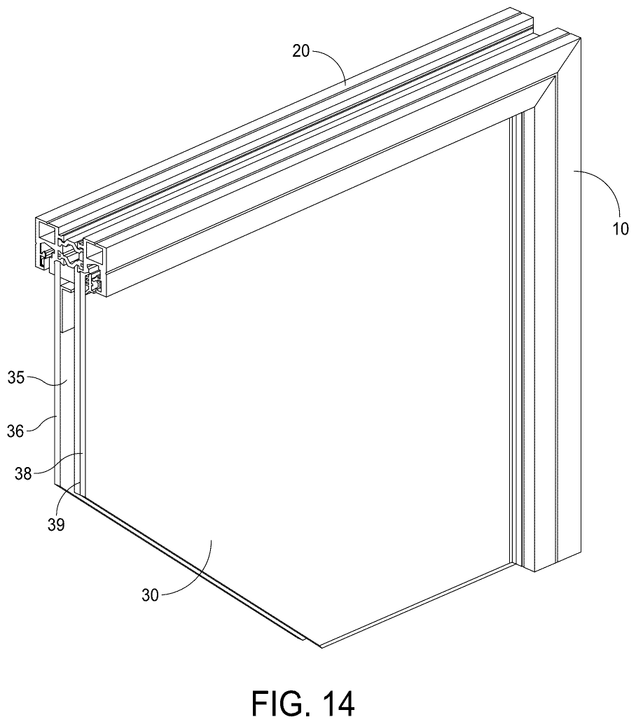

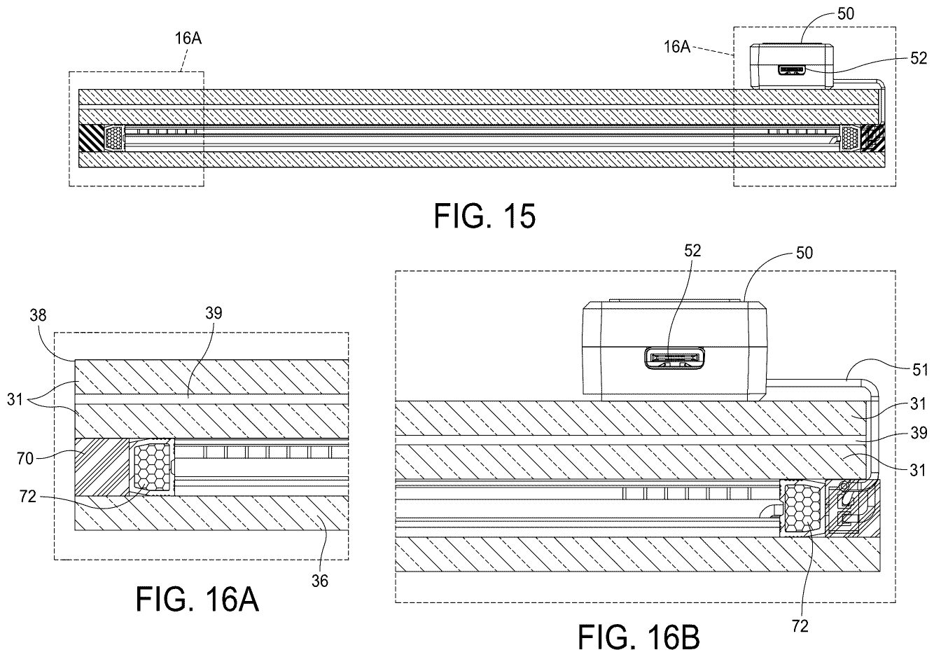

FIG. 14 is a perspective and sectional view illustrating a portion of the exemplary door of FIG. 10 in accordance with some embodiments. FIG. 15 is a sectional view (in a horizontal direction) illustrating the exemplary door of FIG. 10. FIGS. 16A-16B are sectional views illustrating two corner portions of the exemplary door of FIG. 10. FIGS. 14-16B further illustrate the structure of the door 300 as shown in FIGS. 12 and 13A-13B.

The present disclosure also provides a kit of making the door 300, and a method of making the door 300.

In the door described herein, the glazing unit, which is also called insulated glass unit (IGU), may have a suitable thickness. The insulated glass unit (IGU) for doors may be a high-performance option used to improve energy efficiency, sound control, and safety. At least one glass pane includes low-E coating, and the interior of the IGU may be filled with argon gas.

The door described herein meet the international standard (IP65) rating for weather resistance. IP65 is the International Protection standard, in which IP 65 is followed by two specific digits. The first digit (6) means dust-tight, and this is the highest possible rating for solid objects. It means the device is completely sealed against dust, grit, and other fine particulates. The second digit (5) is for water jet protection, and the door is protected against low-pressure water jets (e.g., from a 6.3 mm nozzle) sprayed from any angle. The door can handle heavy rain and splashes.

The door, the kit, the system, and the methods described herein also has environmental sustainability. The production process of the solar-powered mini-blinds or switchable film emphasizes sustainability. The materials used, including high-purity silicon for the solar panels and recyclable aluminum alloys for the mini-blinds, are eco-friendly and recyclable. Additionally, the system's design helps reduce carbon emissions by utilizing solar energy to operate the blinds, contributing to energy savings in homes and businesses.

The installation process is user-friendly, with the system designed to fit seamlessly into various fiberglass doors. The system can be installed by homeowners with basic tools, though professional installation is recommended for optimal performance. Customization options, such as size, color, and frame finishes, allow the system to be adapted to different door types.

The door and the system have at least the following advantages:
1. Energy Efficiency: The solar-powered system reduces reliance on electrical energy, leading to significant savings in heating, cooling, and electricity costs.
2. Sustainability: The system uses environmentally friendly materials and contributes to reducing carbon footprints.
3. Ease of Installation: The system is designed for easy installation, without the need for complex wiring or external units.
4. Durability: The system is built to withstand extreme weather conditions, making it suitable for both interior and exterior door installations.
5. Smart Integration: The system offers compatibility with smart home devices for added convenience.

The solar-powered mini-blind or switchable film system integrated into fiberglass doors provides an innovative and energy-efficient solution for both residential and commercial applications. By harnessing solar energy, the system reduces energy consumption, contributes to sustainability, and offers an aesthetically pleasing, easy-to-install alternative to traditional window treatments.

The door having a solar panel and a switchable film as described have additional benefits. Such a door has the feature of privacy on demand, in which a user can switch the glass panel from clear to frosted in seconds using a remote, mobile app, or voice control. It is highly energy efficient. The glass features a low-E coating that reduces indoor heat loss in winter and lowers air conditioning demand in summer, potentially saving 30%-50% in total energy costs. The door is eco-friendly and safe: The system utilized clean solar energy and is constructed from tempered laminated glass, which ensures fragments stay attached to the interlayer if broken. The door also needs low maintenance. With no moving parts like traditional blinds outside the door, the glass requires less routine upkeep and maintains a minimal, modern appearance.

Wireless Installation (No Wiring Needed): Because it is solar-powered, there is no need to run electrical wires through the door frame or hinges, making it much easier and cheaper to install than traditional powered smart glass.

Because such a door provides instant privacy without using blinds, it is ideal for front doors or office doors, it provides instant privacy at the touch of a button without the need for bulky curtains or blinds that can rattle when the door moves.

The door also provides acoustic and thermal comfort. The laminated construction provides better sound reduction than standard single-pane glass, helping to keep outdoor noise out of the home or office.

The door also provides UV protection. The glass blocks over 90% of UV rays, protecting interior flooring and nearby furniture from fading due to sun exposure through the door.

The door described herein includes smart home integration. The privacy can be controlled via mobile app or smart home systems. The door also has excellent durability, and last at least ten years, for example twenty years.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A door comprising:
a first skin including a first skin body portion providing a first outer door surface;
a second skin including a second skin body portion providing a second outer door surface, wherein each of the first skin and the second skin defines an opening;
a glazing unit comprising two glass panes, the glazing unit having an edge disposed between the first skin and the second skin and the glazing unit disposed within the opening, wherein the glazing unit comprises a solar panel and a set of blinds or a switchable film disposed inside the glazing unit, the set of blinds comprises a plurality of blades oriented in parallel, and the switchable film comprises liquid crystals and is configured to change transparency upon application of electricity; and
a rechargeable battery electrically connected with the solar panel and store electricity from the solar panel, wherein the rechargeable battery is configured to provide power to direct movement of the set of blinds through a motor mechanically connected with the set of the blinds, or change the transparency of the switchable film.

2. The door of claim 1, wherein the set of blinds is disposed between the two glass panes.

3. The door of claim 1, wherein the switchable film is disposed inside or on the surface of one of the two glass panes.

4. The door of claim 1, wherein the switchable film is configured to orient the liquid crystals and become transparent when it is powered on, and become opaque or translucent when it is powered off.

5. The door of claim 1, wherein the rechargeable battery or the motor are disposed between the two glass panes inside the glazing unit, or disposed outside the glazing unit.

6. The door of claim 5, further comprising a controller disposed on the first exterior surface defined by the first skin, and electrically connected with the rechargeable battery and the motor, respectively.

7. The door of claim 6, wherein the controller is configured to control, through the motor, rotation of each blade in the set of blinds and up-and-down motion of the set of blinds, or to control the transparency of the switchable film.

8. The door of claim 6, further comprising a switching circuit electrically connected with the solar panel and the rechargeable battery.

9. The door of claim 6, wherein the controller is configured to detect charging capacity of the rechargeable battery, and turn on or off the switching circuit when the charging capacity is less than or reaches 100% so as to recharge or stop recharging of the rechargeable battery.

10. The door of claim 6, wherein the controller includes a charging port configured to charge the rechargeable battery if additional power is needed.

11. The door of claim 6, further comprising a remote control physically detached from the controller and configured to wirelessly coupled with the controller to direct the movement of the set of blinds or change the transparency of the switchable film.

12. The door of claim 6, wherein the controller is configured to function via a mobile app in a smart device physically detached from the door.

13. The door of claim 6, wherein the controller is a controller with maximum power point tracking (MPPT).

14. The door of claim 6, wherein the rechargeable battery is disposed inside the controller.

15. The door of claim 1, wherein each blade is made of aluminum or aluminum alloy, and the plurality of blades are connected with strings.

16. The door of claim 1, wherein each of the first skin and the second skin comprises a glass fiber filled polymer composite.

17. A door comprising:
a first skin including a first skin body portion providing a first outer door surface;
a second skin including a second skin body portion providing a second outer door surface, wherein each of the first skin and the second skin defines an opening;
a glazing unit comprising two glass panes, the glazing unit having an edge disposed between the first skin and the second skin and the glazing unit disposed within the opening, wherein the glazing unit comprises a solar panel and a set of blinds disposed between the two glass panes, the set of blinds comprise a plurality of blades oriented in parallel;
a rechargeable battery electrically connected with the solar panel and store electricity from the solar panel; and
a motor mechanically connected with the set of the blinds and configured to direct movement of the set of blinds by using power from the rechargeable battery.

18. A door comprising:
a first skin including a first skin body portion providing a first outer door surface;
a second skin including a second skin body portion providing a second outer door surface, wherein each of the first skin and the second skin defines an opening;
a glazing unit comprising two glass panes, the glazing unit having an edge disposed between the first skin and the second skin and the glazing unit disposed within the opening, wherein the glazing unit comprises a solar panel and a switchable film disposed inside the glazing unit, and the switchable film comprises liquid crystals and is configured to change transparency upon application of electricity; and
a rechargeable battery electrically connected with the solar panel and store electricity from the solar panel,
wherein the rechargeable battery is configured to provide power for changing the transparency of the switchable film.

19. The door of claim 18, wherein the switchable film is disposed inside or on the surface of one of the two glass panes, and the switchable film is configured to orient the liquid crystals and become transparent when it is powered on, and become opaque or translucent when it is powered off.

20. A kit for making the door of claim 1, comprising:
the first skin;
the second skin; and
the glazing unit, wherein the glazing unit comprises the solar panel and the set of blinds or the switchable film;
the rechargeable battery; and
optionally the motor, wherein each component is configured to be connected together to provide a the door of claim 1.

21. The kit of claim 20, further comprising a controller and/or a switching circuit.

22. A method for making the door of claim 1, comprising:
providing the first skin and the second skin;
providing the glazing unit comprising the solar panel and the set of blinds or the switchable film therein;
installing the glazing unit to the first skin; and
connecting the first skin and the second skin.

23. The method of claim 22, further comprising providing or connecting a rechargeable battery and the motor.

24. The method of claim 22, further comprising installing a controller on an exterior door surface.
